(19) United States
(12) Patent Application Publication
(10) Pub. No.: US 2021/0295223 A1
(43) Pub. Date: Sep. 23, 2021

(54) COGNITIVE AUTOMATION BASED VENDOR COMPLIANCE SYSTEM

(71) Applicant: Bank of America Corporation, Charlotte, NC (US)

(72) Inventors: Ion C. Freeman, Brooklyn, NY (US); Maria Carolina Barraza, New York, NY (US); Richard S. Scot, Huntersville, NC (US); Elena Kvochko, New York, NY (US); Monika Kapur, Jacksonville, FL (US); Jinna Kim, Charlotte, NC (US); Michael Ogrinz, Easton, CT (US); George Albero, Charlotte, NC (US); Siten Sanghvi, Westfield, NJ (US)

(21) Appl. No.: 16/824,879

(22) Filed: Mar. 20, 2020

(51) Int. Cl. G06Q 10/06; G06Q 30/02; G06Q 30/06; G06Q 30/00; G06Q 10/10; G06F 11/30; G06F 11/34; G06F 16/245; G06N 20/00

(52) U.S. Cl. CPC G06Q 10/0639; G06Q 30/0282; G06Q 30/0631; G06Q 30/018; G06N 20/00; G06F 11/302; G06F 11/3428; G06F 16/245; G06Q 10/10

(57) ABSTRACT

Aspects of the disclosure relate to a cognitive automation based vendor compliance system. A computing platform may monitor, via an enterprise network, use of a software product hosted by an enterprise computing infrastructure. Subsequently, the computing platform may determine a product usage score, where the product usage score is indicative of a number network devices using the software product. Then, the computing platform may determine, for the software product, a product performance score, where the product performance score is indicative of one or more performance issues associated with the software product. Then, the computing platform may compare, for the software product, at least one of: (1) the product usage score to a product usage threshold, and (2) the product performance score to a product performance threshold. Subsequently, the computing platform may recommend, based on the comparing, one or more actions associated with the software product.

### BACKGROUND

Aspects of the disclosure relate to deploying digital data processing systems to manage network resources. In particular, one or more aspects of the disclosure relate to a cognitive automation based vendor compliance system.

Enterprise organizations may utilize various resources to support their computing infrastructure. In many instances, these resources are provided by vendors. For large enterprise organizations, maintaining, updating, and managing utilization of the resources from the vendors over the various enterprise resources may be of significant importance in maintaining an efficient and updated computing infrastructure. It may be helpful to automatically analyze utilization of resources, and generate automated recommendations for whether or not to renew contracts. Also, it may be helpful to automatically analyze contracts and update terms of the contract based on updated policies of the enterprise organization. Ensuring that vendor compliance is maintained, and timely and targeted analysis of resource utilization is performed, in real-time with speed and accuracy, may be particularly advantageous to ensure a smooth running of an enterprise infrastructure. In many instances, however, it may be difficult to analyze resource utilization and determine vendor compliance, in an organization's complex network comprising a vast number of network devices and users, while also attempting to optimize network resources, bandwidth utilization, and efficient operations of the computing infrastructure.

### SUMMARY

Aspects of the disclosure provide effective, efficient, scalable, fast, reliable, and convenient technical solutions that address and overcome the technical problems associated with vendor compliance processes.

In accordance with one or more embodiments, a computing platform having at least one processor, and memory may monitor, via an enterprise network, use of a software product hosted by an enterprise computing infrastructure. Subsequently, the computing platform may determine a product usage score, where the product usage score is indicative of a number network devices using the software product. Then, the computing platform may determine, for the software product, a product performance score, where the product performance score is indicative of one or more performance issues associated with the software product. Then, the computing platform may compare, for the software product, at least one of: (1) the product usage score to a product usage threshold, and (2) the product performance score to a product performance threshold. Subsequently, the computing platform may recommend, based on the comparing, one or more actions associated with the software product.

In some embodiments, the computing platform may display, in near real-time and via a graphical user interface and for the software product, network information in a tabulated list comprising at least one of: the product usage score, the product usage threshold, the product performance score, the product performance threshold, and a cost of the software product.

In some embodiments, the computing platform may detect, via the enterprise network, a new software product hosted by the enterprise computing infrastructure. Subsequently, the computing platform may automatically add a new row to the tabulated list, where the new row comprises network information for the new software product.

In some embodiments, vendor management computing platform may train a machine learning model to, based on an analysis of a utilization of the software product, re-deploy existing licenses of the software product across the enterprise infrastructure.

In some embodiments, the computing platform may determine a product score by aggregating the product usage score and the product performance score. Then, the computing platform may determine a vendor value for a vendor by aggregating product scores for all software products associated with the vendor. Subsequently, the computing platform may compare the vendor value to a threshold vendor value. Then, the computing platform may, upon a determination that the vendor value for the vendor does not exceed the threshold vendor value for a predetermined time threshold, automatically determine not to renew one or more of the software products associated with the vendor.

In some embodiments, the product usage threshold may be based on a number of a licenses available for the software product.

In some embodiments, the product usage threshold may be based on a cost of the software product. In some embodiments, the computing platform may determine the cost of the software product based on a cost of one or more of: an associated operating system, an associated database, and an associated charting library.

In some embodiments, the computing platform may determine that the product usage score exceeds the product usage threshold, and the one or more actions may include recommending purchase of additional licenses for the software product.

In some embodiments, the computing platform may determine that the product usage score does not exceed the product usage threshold for a predetermined time threshold, and the one or more actions may include recommending purchase of fewer than an existing number of licenses for the software product.

In some embodiments, the computing platform may determine a minimum product usage threshold. Then, the computing platform may determine that the product usage score does not exceed the minimum product usage threshold for a predetermined time threshold, and the one or more actions may include recommending no further purchase of the software product.

In some embodiments, the product performance threshold may be based on one or more of: a number of bugs identified in the software product, a number of breaches associated with the software product, a time spent on resolving performance issues associated with the software product, a length of time the software product is in use, an amount of network resources utilized by the software product, an impact on other network devices, an impact on other software products, and a cost of maintenance associated with the software product.

In some embodiments, the computing platform may determine that the product performance score exceeds the product performance threshold, and the one or more actions may include recommending purchase of more than an existing number of licenses for the software product.

In some embodiments, the computing platform may determine that the product performance score does not exceed the product performance threshold for a predetermined time threshold, and the one or more actions may include recommending purchase of less than an existing number of licenses for the software product.

In some embodiments, the computing platform may determine the product performance score by determining a product compliance score indicative of a level of compliance of the software product with enterprise policies.

In some embodiments, the one or more actions may include recommending a renewal of a contract associated with a license for the software product, and the computing platform may conduct an image analysis of the contract. Then, the computing platform may retrieve, based on the image analysis and from a database of contract terms, one or more terms relevant to the contract. Subsequently, the computing platform may compare terms of the contract to the one or more terms relevant to the contract. Then, the computing platform may identify, based on the comparing of terms, at least one term of the contract for review. In some embodiments, the computing platform may automatically modify, based on the comparing of terms, the at least one term.

In some embodiments, the computing platform may determine that a second software product provides similar functionalities as the software product, Then, the computing platform may recommend the one or more actions by selecting between the software product and the second software product.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for a cognitive automation based vendor compliance system in accordance with one or more example embodiments;

FIG. 2 depicts an illustrative event sequence for a cognitive automation based vendor compliance system in accordance with one or more example embodiments;

FIG. 3 depicts an illustrative method for a cognitive automation based vendor compliance system in accordance with one or more example embodiments;

FIG. 4 depicts an illustrative method for a cognitive automation based vendor compliance system in accordance with one or more example embodiments; and

FIG. 5 depicts an illustrative method for a cognitive automation based vendor compliance system in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to a cognitive automation based vendor compliance system. For example, an enterprise network management infrastructure may deploy computing resources such as software products to perform various tasks of an enterprise organization. In some instances, the software products may be provided by vendors. Generally, the software products may be accompanied by license metrics, use restrictions, and so forth. In some instances, two or more software products may be providing similar functionalities. As another example, some software products may not be utilized and/or may be under-utilized, and/or additional licenses may need to be purchased for some software products (e.g., due to a high volume of use). In some instances, changes in policies of an enterprise organization may cause changes in relationships with some vendors. Also, for example, the software products may be purchased under a contract with the vendor, and terms of such contracts may need to be updated to be compliant with policies of the enterprise organization. For large enterprise organizations with vast amounts of deployed resources, a large number of employees, and a large client-base, utilization of the software products may take varied and complex forms, and it may be advantageous to provide a real-time system to monitor use of the software products, automatically monitor terms in contracts, and/or update these terms based on existing enterprise policies.

Generally, it may not be possible to manually monitor utilization of software products by such a vast array of network applications and devices, with near-continuous utilization of network resources. Accordingly, it may be of great significance for a large enterprise organization (e.g., financial institution), with large amounts of computing resources, to monitor utilization of software products, and automatically maintain vendor compliance by updating terms in a contract.

Accordingly, aspects of this disclosure relate to automated monitoring of utilization of software products, and automated analysis of relevant contracts. Monitoring utilization of software products via a manual process and/or based on mental steps is unlikely because it relates to vast amounts of real-time use that may be rapidly changing in real-time over thousands of enterprise resources, potentially spread over resources in different geographical regions. Also, since software products may be utilized by a vast array of users, internal and external applications, and network devices, it necessitates a use of computing devices to perform the monitoring. Similarly, analyzing a large volume of contracts via a manual process and/or based on mental steps is unlikely because of varying lengths of contracts, complexities of terms that may have been negotiated over time by different business units, and also adapting to changes in policies of the enterprise organization, and/or maintaining consistency of contract terms across the enterprise organization. As another example, determining, in real-time, an amount of network resources used (e.g., processing power, memory resources, network bandwidth, and so forth) via a manual process and/or based on mental steps is also highly unlikely.

It may be noted, that as utilization of software products occur over a computing network, the problem of optimizing such utilization arises in the realm of networks, and as described herein, a solution is necessarily rooted in computer technology to overcome a problem arising in the realm of computer networks.

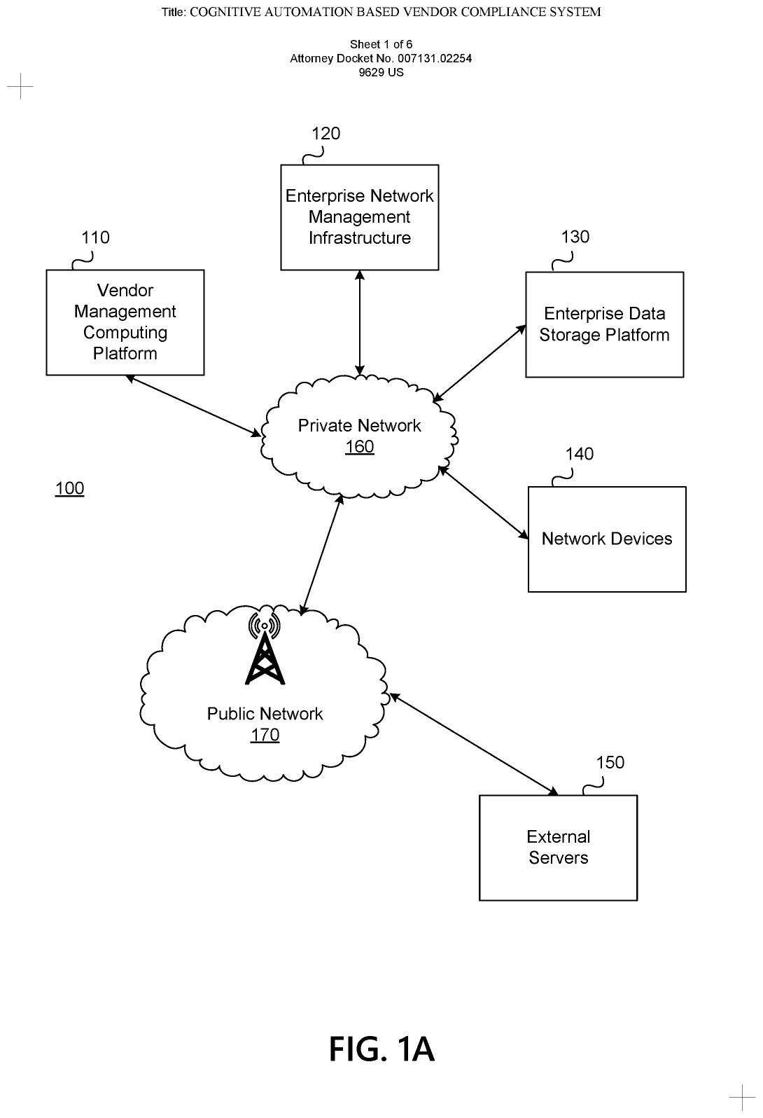

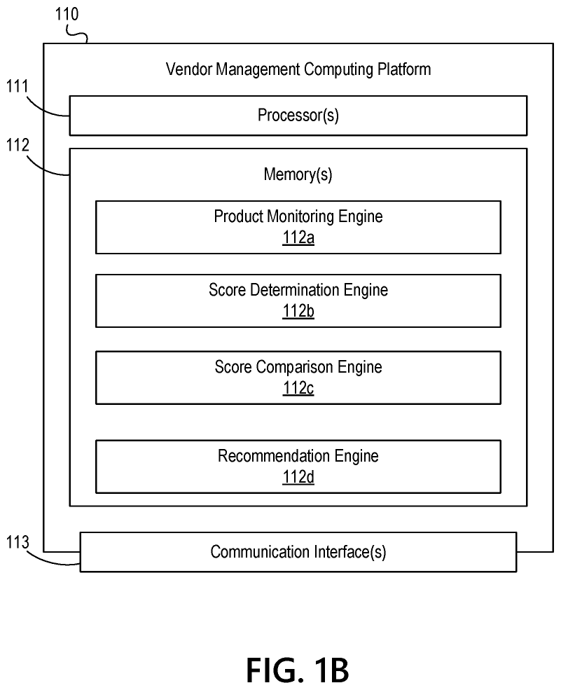

FIGS. 1A and 1B depict an illustrative computing environment for a cognitive automation based vendor compliance system in accordance with one or more example embodiments. Referring to FIG. 1A, computing environment 100 may include one or more computer systems. For example, computing environment 100 may include vendor management computing platform 110, enterprise network management infrastructure 120, enterprise data storage platform 130, network devices 140, and external servers 150.

As illustrated in greater detail below, vendor management computing platform 110 may include one or more computing devices configured to perform one or more of the functions described herein. For example, vendor management computing platform 110 may include one or more computers (e.g., laptop computers, desktop computers, servers, server blades, or the like) and/or other computer components (e.g., processors, memories, communication networks).

Enterprise network management infrastructure 120 may include one or more computing devices and/or other computer components (e.g., processors, memories, communication interfaces). In addition, enterprise network management infrastructure 120 may be configured to manage, host, execute, and/or otherwise provide one or more enterprise applications and/or devices (e.g., network devices 140). For example, enterprise network management infrastructure 120 may be configured to manage, host, execute, and/or otherwise provide a computing platform for various network devices and software products. In some instances, enterprise network management infrastructure 120 may be configured to provide various enterprise and/or back-office computing functions for an enterprise organization, such as a financial institution. For example, enterprise network management infrastructure 120 may include various servers and/or databases that store and/or otherwise maintain information, such as information related to purchase of licensed products, transaction history, vendor information, contracts, enterprise policies, human resource policies, data protection, transmission, and retention policies, and/or other information. Also, for example, enterprise network management infrastructure 120 may include various servers and/or databases that may manage information technology resources for the enterprise organization. Additionally, or alternatively, enterprise network management infrastructure 120 may receive instructions from vendor management computing platform 110 and execute the instructions in a timely manner.

Enterprise data storage platform 130 may include one or more computing devices and/or other computer components (e.g., processors, memories, communication interfaces). In addition, and as illustrated in greater detail below, enterprise data storage platform 130 may be configured to store and/or otherwise maintain enterprise data, including data exchanged between network devices and/or other resources hosted, executed, and/or otherwise provided by enterprise network management infrastructure 120. Also, for example, enterprise data storage platform 130 may be configured to store and/or otherwise maintain information associated with data transmissions between enterprise applications and/or devices (e.g., network devices 140), and/or between an enterprise application and/or device and an external vendor application, user computing device (e.g., external servers 150). Additionally, or alternatively, enterprise network management infrastructure 120 may load data from enterprise data storage platform 130, manipulate and/or otherwise process such data, and return modified data and/or other data to enterprise data storage platform 130 and/or to other computer systems included in computing environment 100.

Network devices 140 may be devices, servers, and so forth configured to host applications utilized by the enterprise organization, and managed, hosted, executed, and/or otherwise provided by enterprise network management infrastructure 120. For example, network devices 140 may host software products related to a word processing application, a telecommunications application, human resource application, a travel management application, a health insurance provider application, payment processing application, a voice over IP (“VOIP”) service application, and so forth. In some embodiments, network devices 140 may be user devices that use software products. The term “software product” as used herein, may generally refer to any software product used within an enterprise organization. For example, a software product may run a stand-alone enterprise application, or run a suite of enterprise applications.

External servers 150 may be a device, server, and so forth configured to provide information related to the enterprise organization. For example, external servers 150 may provide information related to data privacy, vendor management, information security, and so forth.

Computing environment 100 may include one or more networks, which may interconnect one or more of vendor management computing platform 110, enterprise network management infrastructure 120, enterprise data storage platform 130, network devices 140, and external servers 150. For example, computing environment 100 may include private network 160 (which may interconnect, for example, vendor management computing platform 110, enterprise network management infrastructure 120, enterprise data storage platform 130, network devices 140, and/or one or more other systems (which may be associated with an organization, such as a financial institution), and public network 170 (which may interconnect, for example, external servers 150 with private network 160 and/or one or more other systems, public networks, sub-networks, and/or the like). For example, public network 170 may interconnect external servers 150 with vendor management computing platform 110 via private network 160. In some instances, public network 170 may be a high generation cellular network, such as, for example, a fifth generation (“5G”) or higher cellular network. In some instances, private network 160 may likewise be a high generation cellular enterprise network, such as, for example, a 5G or higher cellular network.

In one or more arrangements, vendor management computing platform 110, enterprise network management infrastructure 120, enterprise data storage platform 130, network devices 140, and external servers 150, and/or the other systems included in computing environment 100 may be any type of computing device capable of communicating with a user interface, receiving input via the user interface, and communicating with one or more other computing devices. For example, vendor management computing platform 110, enterprise network management infrastructure 120, enterprise data storage platform 130, network devices 140, external servers 150, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of vendor management computing platform 110, enterprise network management infrastructure 120, enterprise data storage platform 130, network devices 140, and external servers 150, may, in some instances, be special-purpose computing devices configured to perform specific functions.

Referring to FIG. 1B, vendor management computing platform 110 may include one or more processors 111, memory 112, and communication interface 113. A data bus may interconnect processor 111, memory 112, and communication interface 113. Communication interface 113 may be a network interface configured to support communication between vendor management computing platform 110 and one or more networks (e.g., public network, private network, a local network, or the like). Memory 112 may include one or more program modules having instructions that when executed by processor 111 cause vendor management computing platform 110 to perform one or more functions described herein and/or one or more databases that may store and/or otherwise maintain information which may be used by such program modules and/or processor 111. In some instances, the one or more program modules and/or databases may be stored by and/or maintained in different memory units of vendor management computing platform 110 and/or by different computing devices that may form and/or otherwise make up vendor management computing platform 110. For example, memory 112 may have, store, and/or include product monitoring engine 112a, score determination engine 112b, score comparison engine 112c, and recommendation engine 112d.

Product monitoring engine 112a may have instructions that direct and/or cause vendor management computing platform 110 to monitor, via an enterprise network, use of a software product hosted by an enterprise computing infrastructure.

Score determination engine 112b may have instructions that direct and/or cause vendor management computing platform 110 to determine a product usage score, where the product usage score is indicative of a number network devices using the software product. In some embodiments, score determination engine 112b may have instructions that direct and/or cause vendor management computing platform 110 to determine, for the software product, a product performance score, where the product performance score is indicative of one or more performance issues associated with the software product.

Score comparison engine 112c may have instructions that direct and/or cause vendor management computing platform 110 to compare, for the software product, at least one of: (1) the product usage score to a product usage threshold, and (2) the product performance score to a product performance threshold.

Recommendation engine 112d may have instructions that direct and/or cause vendor management computing platform 110 to recommend, based on the comparing, one or more actions associated with the software product. In some embodiments, recommendation engine 112d may have instructions that direct and/or cause vendor management computing platform 110 to display, in near real-time and via a graphical user interface and for the software product, network information in a tabulated list comprising at least one of: the product usage score, the product usage threshold, the product performance score, the product performance threshold, and a cost of the software product. In some embodiments, recommendation engine 112d may have instructions that direct and/or cause vendor management computing platform 110 to train a machine learning model to, based on an analysis of a utilization of the software product, re-deploy existing licenses of the software product across the enterprise infrastructure.

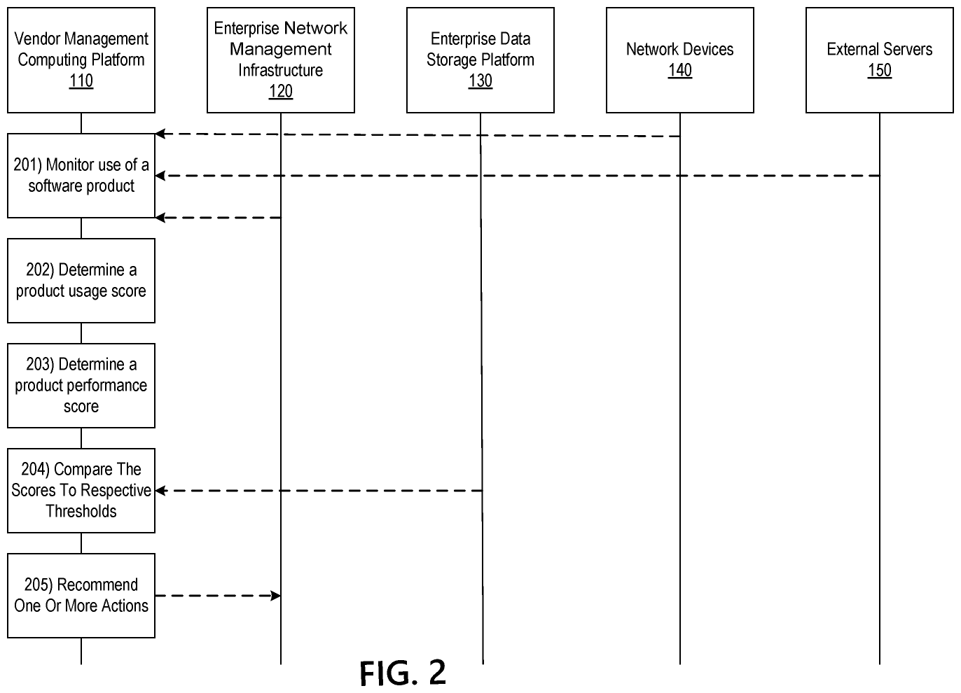

FIG. 2 depicts an illustrative event sequence for a cognitive automation based vendor compliance system in accordance with one or more example embodiments. Referring to FIG. 2, at step 201, vendor management computing platform 110 may monitor, via an enterprise network, use of a software product hosted by an enterprise computing infrastructure. For example, vendor management computing platform 110 may be configured to maintain a running list of all instances of the software product. For example, a task processing system in each enterprise computing device may detect that an instance of the software product has been initiated, and send a network message to vendor management computing platform 110, which may in turn, maintain a list of all currently running instances. In some embodiments, enterprise network management infrastructure 120 may deploy one or more servers to host the software product. Accordingly, vendor management computing platform 110 may query the one or more servers and retrieve a number of instances of the software product. Such a query may be initiated at regular intervals. In some embodiments, the query may be tied to a time for license renewal activity. For example, a licensed software product may be due for renewal, and vendor management computing platform 110 may query the one or more servers prior to the date of renewal. In some embodiments, vendor management computing platform 110 may query the one or more servers two months before the renewal date so at to obtain applicable approvals, and perform appropriate reviews.

At step 202, vendor management computing platform 110 may determine a product usage score, where the product usage score is indicative of a number network devices using the software product. For example, vendor management computing platform 110 may identify a number of users of a software product, a frequency of use of the software product, and/or a time duration of use of the software product. In some embodiments, vendor management computing platform 110 may determine use of the software product by each business unit within the enterprise organization. For example, a word processing application may be utilized by a large number of users across all business units. However, a legal tracking system may be utilized by a legal department. Similarly, a network monitoring system may be utilized by a security business unit and an information technology business unit.

In some embodiments, vendor management computing platform 110 may determine the product usage score as a number of instances of the software product that may be in use. For example, vendor management computing platform 110 may determine the product usage score as an average number of instances of the software product that may be in use in a given time interval. In some embodiments, vendor management computing platform 110 may determine the product usage score as an aggregate of the one or more factors described herein. For example, vendor management computing platform 110 may determine the product usage score as a weighted average of a fraction of instances of the software product that may be in use in a given time interval with respect to a total number of instances available for use, a fraction indicating the frequency of use of the software product, and so forth.

At step 203, vendor management computing platform 110 may determine, for the software product, a product performance score, where the product performance score is indicative of one or more performance issues associated with the software product. For example, vendor management computing platform 110 may determine a number of bug fixes for the software product, a number of viruses or other unauthorized activity associated with the software product, and/or a number of breaches associated with the software product. In some embodiments, vendor management computing platform 110 may determine a number of run-time errors associated with the software product. For example, a network device running an instance of the software product may be configured to send a summary report to vendor management computing platform 110 where the report provides information related to a performance of the software product. Also, for example, vendor management computing platform 110 may retrieve data from call logs to a support team, and/or chat sessions with a support team, and determine performance related information by processing the call logs.

In some embodiments, vendor management computing platform 110 may determine the product performance score by determining a product compliance score indicative of a level of compliance of the software product with enterprise policies. For example, the enterprise organization may determine one or more factors in determining the level of compliance. For example, the enterprise organization may have policies related to how confidential data is to be processed. For example, the enterprise organization may require that confidential data needs to be encrypted in transit. Accordingly, vendor management computing platform 110 may determine if the software product is in compliance with this policy by determining if the confidential data is being encrypted appropriately. Based on a determination that the confidential data is being encrypted appropriately, vendor management computing platform 110 may determine the product compliance score to be “1”. As another example, based on a determination that the confidential data is not being encrypted appropriately, vendor management computing platform 110 may determine the product compliance score to be “0”. Values for the product compliance score between “0” and “1” may also be used. For example, if the confidential data is being encrypted appropriately in certain times and not at other times, vendor management computing platform 110 may determine the product compliance score to be between “0” and “1”. For example, if the confidential data is being encrypted 80% of the time, vendor management computing platform 110 may determine the product compliance score to be “0.8”.

Also, for example, the enterprise organization may require that confidential data be stored in specified locations. Accordingly, vendor management computing platform 110 may determine if the software product is in compliance with this policy by determining if the confidential data is being stored in the specified locations. Based on a determination that the confidential data is being stored in the specified locations, vendor management computing platform 110 may determine the product compliance score to be “1”. As another example, based on a determination that the confidential data is not being stored in the specified locations, vendor management computing platform 110 may determine the product compliance score to be “0”.

In some embodiments, vendor management computing platform 110 may determine the product performance score as an aggregate of the one or more factors described herein. Generally, a software product that has a high level of performance (e.g., fewer number of bugs, fewer runtime errors, fewer known viruses, and so forth) may be associated with a high product performance score, whereas a software product that has a low level of performance (e.g., higher number of bugs, higher number of runtime errors, several known viruses, and so forth) may be associated with a low product performance score.

At step 204, vendor management computing platform 110 may compare, for the software product, at least one of: (1) the product usage score to a product usage threshold, and (2) the product performance score to a product performance threshold. For example, vendor management computing platform 110 may compare the product usage score to the product usage threshold. In some embodiments, the product usage threshold may be based on a number of a licenses available for the software product. For example, vendor management computing platform 110 may determine that on any given day, an average of 12,000 instances of the software product were run concurrently. Accordingly, vendor management computing platform 110 may determine the product usage score to be 12,000. Also, for example, via a document analysis of a contract associated with the software product, vendor management computing platform 110 may determine that the enterprise organization may run 60,000 instances of the software product. Accordingly, vendor management computing platform 110 may determine the product usage threshold to be 60,000. Subsequently, vendor management computing platform 110 may compare the product usage score (12,000) to the product usage threshold (60,000) to determine that product usage score (12,000) is less than the product usage threshold (60,000).

In some embodiments, the product usage threshold may be based on a cost of the software product. For example, if the cost of the software product is high, vendor management computing platform 110 may determine the product usage threshold to be high. As another example, if the cost of the software product is low, vendor management computing platform 110 may determine the product usage threshold to be low. This may be indicative of a return on the investment on a purchase of the software product. For example, an enterprise organization may place a greater emphasis on use of a software that is more expensive.

In some embodiments, vendor management computing platform 110 may determine the cost of the software product based on a cost of one or more of: an associated operating system, an associated database, and an associated charting library. For example, each time an instance of a software product is run, it uses processing power, memory resources, databases and libraries. Also, for example, if an application is run via a cloud server, there may be additional cost associated with utilization of cloud computing resources. Vendor management computing platform 110 may determine an aggregate cost of all such computing resources utilized.

In some embodiments, the product performance threshold may be based on one or more of: a number of bugs identified in the software product, a number of breaches associated with the software product, a time spent on resolving performance issues associated with the software product, a length of time the software product is in use, an amount of network resources utilized by the software product, an impact on other network devices, an impact on other software products, and a cost of maintenance associated with the software product.

For example, if the software product is associated with a large number of bugs, a large number of breaches, and/or a longer amount of time spent on resolving performance issues, vendor management computing platform 110 may determine the product performance threshold to be high. Also, for example, if the software product is associated with a fewer number of bugs, a fewer number of breaches, and/or a less amount of time spent on resolving performance issues, vendor management computing platform 110 may determine the product performance threshold to be low. Accordingly, product performance threshold may be indicative of a level of risk associated with use of the software product. Also, for example, the software product may impact a performance of another software product. For example, the software product may cause another software product to not run. As another example, the software product may introduce a virus into another software product. Accordingly, vendor management computing platform 110 may adjust the product performance threshold based on one or more such factors.

Also, for example, the software product may impact a performance of another network device. For example, the software product may cause another network device to have performance issues. For example the software product may cause an operating system on a network device to crash. As another example, the software product may introduce a virus into another network device. Accordingly, vendor management computing platform 110 may adjust the product performance threshold based on one or more such factors.

In some embodiments, the product performance threshold may be based on a cost of maintenance associated with the software product. For example, the software product may require a supercomputer to run a core product. As another example, the software product may only run on network devices that must meet a threshold security firewall. Also, for example, there may be a high cost of service requests associated with the software product. Accordingly, vendor management computing platform 110 may adjust the product performance threshold based on one or more such factors.

In some embodiments, vendor management computing platform 110 may determine that the product usage score exceeds the product usage threshold, and one or more actions may include recommending purchase of additional licenses for the software product. For example, vendor management computing platform 110 may determine that for a purchase of 100,000 licenses of a software product, the product usage threshold may be 80%. For example, the product usage threshold may be determined based on a projected use for an upcoming term. For example, it may be determined that at 80% or higher current use, the projected need may increase by 10,000 for the next renewal period. Accordingly, at least 80,000 licenses of the product should be used in order to increase the number of licenses to be purchased. Accordingly, upon a determination that 92,000 licenses of the product are being used, vendor management computing platform 110 may determine that the product usage score is 92,000, and therefore the product usage score (92,000) exceeds the product usage threshold (80,000). Accordingly, vendor management computing platform 110 may recommend purchase of the 10,000 additional licenses. In some embodiments, vendor management computing platform 110 may automatically update a contract to reflect a number of licenses to be purchased as 110,000.

In some embodiments, vendor management computing platform 110 may determine that the product usage score does not exceed the product usage threshold for a predetermined time threshold, and the one or more actions may include recommending purchase of fewer than an existing number of licenses for the software product. For example, vendor management computing platform 110 may determine that for a purchase of 100,000 licenses of a software product, the product usage threshold may be 80%. For example, the product usage threshold may be determined based on a projected use for an upcoming term. For example, it may be determined that if the current use is less than 80%, the projected need may decrease by 5,000 for the next renewal period. Accordingly, at least 80,000 licenses of the product should be used in order to increase the number of licenses to be purchased. Accordingly, upon a determination that 54,000 licenses of the product are being used, vendor management computing platform 110 may determine that the product usage score is 54,000, and therefore the product usage score (54,000) does not exceed the product usage threshold (80,000). Accordingly, vendor management computing platform 110 may recommend purchase of the 5,000 fewer licenses. In some embodiments, vendor management computing platform 110 may automatically update a contract to reflect a number of licenses to be purchased as 95,000.

In some embodiments, vendor management computing platform 110 may determine a minimum product usage threshold. For example, in some embodiments, vendor management computing platform 110 may determine that for a software product to provide a return on an investment, a minimum product usage threshold must be satisfied. For example, in an enterprise organization, there may be software products that were previously purchased, may have been used for a period of time, and are not currently in use. In some instances, the software product may no longer be a viable product for the enterprise organization. Also, for example, the software product may have been replaced by another software product, and/or may have been upgraded to a newer version. Accordingly, the minimum product usage threshold may be a minimum number of users that must use the software product, for example, over a predetermined time interval. In some instances, the minimum product usage threshold may be a minimum number of times that the software product must be used.

In some embodiments, vendor management computing platform 110 may determine that the product usage score does not exceed the minimum product usage threshold for a predetermined time threshold, and the one or more actions may include recommending no further purchase of the software product. For example, vendor management computing platform 110 may determine that for a purchase of 100,000 licenses of a software product, the minimum product usage threshold may be 60%. Accordingly, upon a determination that 18,000 licenses of the product have been used over the last year, vendor management computing platform 110 may determine that the product usage score is 18,000, and therefore the product usage score (18,000) is below the minimum product usage threshold (60,000). Accordingly, vendor management computing platform 110 may recommend that a license and/or contract for purchase of the software product may not be renewed. In some embodiments, vendor management computing platform 110 may generate an alert notification for a contract manager responsible for renewal of the software product. In some embodiments, vendor management computing platform 110 may automatically cause a vendor management system to stop renewal of the software product.

Generally, the minimum product usage threshold may be a bottom line return on investment expectation, whereas the minimum product usage threshold may suggest options for renewal and/or non-renewal of the software product. In some embodiments, a comparison of the product usage score to the product usage threshold may trigger a manual review of a need for the software product, an evaluation of competing products, and so forth.

In some embodiments, vendor management computing platform 110 may determine that the product performance score exceeds the product performance threshold, and the one or more actions may include recommending purchase of more than an existing number of licenses for the software product. For example, vendor management computing platform 110 may determine that the product performance indicates that the software product has had no run-time errors. Accordingly, vendor management computing platform 110 may determine the product performance score to be 100%. Based on the software product, the product performance threshold may have been set to 80% (for e.g., threshold for run-time errors may be 20% of the times an instance of the software product is run). Accordingly, based on a determination that the product performance score, 100%, exceeds the product performance threshold, 80%, vendor management computing platform 110 may recommend purchase of more than an existing number of licenses for the software product.

In some embodiments, vendor management computing platform 110 may determine that the product performance score does not exceed the product performance threshold, and the one or more actions may include recommending purchase of less than an existing number of licenses for the software product. For example, vendor management computing platform 110 may determine that, based on information from external sources (e.g., external servers 150), the software product may have a security vulnerability. Accordingly, vendor management computing platform 110 may determine the product performance score to be 0. Based on the software product, the product performance threshold may have been set to 1 (for e.g., there are no security vulnerabilities in the software product). Accordingly, based on a determination that the product performance score, 0, does not exceed the product performance threshold, 1, vendor management computing platform 110 may recommend purchase of less than an existing number of licenses for the software product. In some embodiments, vendor management computing platform 110 may recommend that the license, and/or contract for purchase of the software product may not be renewed. In some embodiments, vendor management computing platform 110 may generate an alert notification for a security manager indicating that the software product is associated with a security vulnerability, and vendor management computing platform 110 may recommend that further use of the software product in enterprise network management infrastructure 120 be reviewed and/or ceased.

In some embodiments, vendor management computing platform 110 may determine a product score by aggregating the product usage score and the product performance score. For example, vendor management computing platform 110 may determine the product score as a sum of the product usage score and the product performance score. Also, for example, vendor management computing platform 110 may determine the product score as a weighted sum of the product usage score and the product performance score. Generally, the product score may be indicative of a value of the software product to the enterprise organization.

In some embodiments, vendor management computing platform 110 may determine a vendor value for a vendor by aggregating product scores for all software products associated with the vendor. An enterprise organization may purchase and/or license a large number of software products from a vendor. Accordingly, it may be of significant interest for contract managers and other personnel to understand a value of a vendor. In some embodiments, vendor management computing platform 110 may determine the vendor value for the vendor by determining a sum of product scores for all software products associated with the vendor. In some embodiments, vendor management computing platform 110 may determine the vendor value for the vendor by determining a weighted average of product scores for all software products associated with the vendor.

In some embodiments, vendor management computing platform 110 may compare the vendor value to a threshold vendor value. For example, vendor management computing platform 110 may determine the threshold vendor value as a sum or weighted average of the product usage threshold and the product performance threshold. For some vendors, vendor management computing platform 110 may determine the threshold vendor value to be the product usage threshold or the product performance threshold. Generally, the threshold vendor value may be indicative of a value that the enterprise organization expects the vendor to deliver. For example, a vendor that provides a superior product with few runtime errors, bugs, and so forth may be associated with a low threshold vendor value. Accordingly, such a vendor may have a low threshold for renewal of the software product; the enterprise organization may be highly likely to renew the software product. However, a vendor that provides a software product with several runtime errors, several bugs, and other security vulnerabilities, and so forth may be associated with a high threshold vendor value. Accordingly, such a vendor may have a high threshold for renewal of the software product; the enterprise organization may be highly unlikely to renew the software product.

In some embodiments, vendor management computing platform 110 may, upon a determination that the vendor value for the vendor does not exceed the threshold vendor value for a predetermined time threshold, automatically determine not to renew one or more of the software products associated with the vendor. For example, a large enterprise organization may add vendors at various times. However, there may be little or no review of vendor performance, need for the vendor and/or one or more software products provided by the vendor, and so forth. Generally, some software products may continue to be licensed and/or purchased even though there are known issues associated with such products. In some instances, one business unit may have determined not to use a software product, and other business units may continue to use the software product. Accordingly, the vendor value may provide a snap shot of a vendor's value to the enterprise organization. For example, vendor management computing platform 110 may determine the vendor value for the vendor to be 77/100, based on a variety of factors, such as, for example, use of the software product, security vulnerabilities, bug fixes, need for the software product, and so forth. Also, for example, vendor management computing platform 110 may determine the threshold vendor value for the vendor to be 85/100 over the last 6 months, based on a variety of factors, such as, for example, an expected use of the software product, a cost of the software product, an expected number of bug fixes, a number of products licensed and/or purchased from the vendor, and so forth. Accordingly, upon a determination that the vendor value for the vendor, 77/100, does not exceed the threshold vendor value for a predetermined time threshold, 85/100, vendor management computing platform 110 may automatically determine not to renew one or more of the software products associated with the vendor.

At step 205, vendor management computing platform 110 may recommend, based on the comparing, one or more actions associated with the software product. As described herein, the one or more actions may include, for example, a recommendation whether to renew a license to the software product, a recommendation whether to review a contract associated with the software product, generating and sending alert notifications, and so forth.

In some embodiments, the one or more actions may include recommending a renewal of a contract associated with a license for the software product, and vendor management computing platform 110 may conduct an image analysis of the contract. For example, vendor management computing platform 110 may retrieve, from a repository of contracts (e.g., enterprise data storage platform 130), one or more contracts associated with the software product. Subsequently, vendor management computing platform 110 may conduct an image analysis of the one or more contracts. For example, vendor management computing platform 110 may apply optical character recognition (OCR) to process the one or more contracts.

In some embodiments, vendor management computing platform 110 may generate a tabulated document that lists salient features of the contract, such as, for example, a date of execution, names and addresses of parties, a contract number, a type of contract (licensed product, Software-as-a-Service (SaaS), professional service, and so forth), an amount for a limitation of liability, a date of renewal of the contract, and so forth.

In some embodiments, vendor management computing platform 110 may retrieve, based on the image analysis and from a database of contract terms, one or more terms relevant to the contract. For example, vendor management computing platform 110 may retrieve, from a repository of contracts (e.g., enterprise data storage platform 130), the one or more terms. For example, based on the image analysis, vendor management computing platform 110 may identify that the contract includes contractual clauses related to one or more of a limitation of liability, third-party infringement, open source, escrow, assignment, and so forth. Accordingly, vendor management computing platform 110 may retrieve, from the repository of contracts (e.g., enterprise data storage platform 130), one or more terms related to such contractual clauses. For example, a legal department of the enterprise organization may create updated clauses or model clauses for each contractual term. Such model clauses may, for example, be based on updated policies of the enterprise organization.

For example, the enterprise organization may require additional terms in its open source requirements. Accordingly, a model clause with such additional terms may be created and placed in the repository of contracts (e.g., enterprise data storage platform 130). Also, for example, the enterprise organization may require additional terms in its escrow requirements. Accordingly, a model clause with such additional terms may be created and placed in the repository of contracts (e.g., enterprise data storage platform 130). As another example, the enterprise organization may require a higher value for its limitation of liability, and/or add factors (e.g., indirect costs, loss of profits, and so forth) in the contractual term for the limitation of liability. Accordingly, a model clause with such additional terms may be created and placed in the repository of contracts (e.g., enterprise data storage platform 130).

In some embodiments, vendor management computing platform 110 may compare terms of the contract to the one or more terms relevant to the contract. For example, vendor management computing platform 110 may compare the existing terms for open source, escrow, limitation of liability, and so forth to the corresponding model clauses retrieved from the repository of contracts (e.g., enterprise data storage platform 130). For example, vendor management computing platform 110 may compare word processing documents listing the terms of the contract and the one or more terms relevant to the contract (e.g., the model clauses).

In some embodiments, vendor management computing platform 110 may identify, based on the comparing of terms, at least one term of the contract for review. For example, based upon the comparing, vendor management computing platform 110 may determine that the open source terms and the escrow terms in the existing contract match the model clauses. Accordingly, vendor management computing platform 110 may determine that the open source terms and the escrow terms do not need to be modified in a new contract or a renewal of the existing. However, vendor management computing platform 110 may determine that the limitation of liability terms in the existing contract do not match the terms in the corresponding model clause for the limitation of liability. In some embodiments, vendor management computing platform 110 may generate an alert that the contract may need to be reviewed by a contract manager and/or other legal professional. In some embodiments, vendor management computing platform 110 may generate the alert and identify the at least one term, and the one or more terms relevant to the contract.

In some embodiments, vendor management computing platform 110 may automatically modify, based on the comparing of terms, the at least one term. For example, vendor management computing platform 110 may, upon identifying the at least one term of the contract for review, automatically generate a modified contract with updated terms (from the model clauses) inserted to replace the at least one term. For example, upon determining that the limitation of liability terms in the existing contract do not match the terms in the corresponding model clause for the limitation of liability, vendor management computing platform 110 may generate a new document by replacing the limitation of liability terms in the existing contract with the terms in the corresponding model clause for the limitation of liability. In some embodiments, vendor management computing platform 110 may generate an amendment to the contract with the at least one term replaced with the updated term (from a corresponding model clause).

Also, for example, vendor management computing platform 110 may automatically modify names of one or more parties, date of a renewal, an address, and so forth. For example, Company A may have been renamed as Company B (e.g., due to a sale, acquisition, merger, spin-off, and so forth). Accordingly, vendor management computing platform 110 may automatically change “Company A” to “Company B” in a modified contract.

In some embodiments, vendor management computing platform 110 may determine that a second software product provides similar functionalities as the software product. In some instances, an enterprise organization may license and/or purchase a plurality of software products that may offer substantially similar features and/or functionalities. For example, such software products may have been purchased and/or licensed by different business units. Also, for example, such software products may have been purchased at different times from different vendors. Accordingly, vendor management computing platform 110 may classify and/or group all software products by functionality. For example, a similarity measure may be utilized to identify clusters of software products, where software products with similar functionalities may be clustered together.

In some embodiments, vendor management computing platform 110 may recommend the one or more actions by selecting between the software product and the second software product. For example, vendor management computing platform 110 may compare the product usage score for the software product with a second product usage score for the second software product. In some embodiments, vendor management computing platform 110 may select between the two software products by selecting the one with a higher score. In some embodiments, vendor management computing platform 110 may select between the two software products by selecting the one that has a product usage score that exceeds the product usage threshold.

Similar selections may be made based on a comparison of product performance scores. In some embodiments, vendor management computing platform 110 may select between the two software products by selecting the software product with a higher product compliance score. In some embodiments, vendor management computing platform 110 may select between the two software products by selecting the software product provided by a vendor with a higher vendor value.

In some embodiments, vendor management computing platform 110 may display, in near real-time and via a graphical user interface and for the software product, network information in a tabulated list comprising at least one of: the product usage score, the product usage threshold, the product performance score, the product performance threshold, and a cost of the software product. For example, vendor management computing platform 110 may provide a dashboard that displays information about software products. In some embodiments, vendor management computing platform 110 may display trends in one or more scores determined herein. In some embodiments, vendor management computing platform 110 may display the information categorized by vendor, business unit, type of product, and so forth. In some embodiments, vendor management computing platform 110 may rank the software products based on the one or more scores determined herein. In some embodiments, vendor management computing platform 110 may rank vendors based on vendor values.

In some embodiments, vendor management computing platform 110 may display information in a tabular format. For example, a row in the table may represent information for a software product, and columns may provide network information such as the product usage score, the product usage threshold, the product performance score, the product performance threshold, and a cost of the software product, a business unit or units using the software product, one or more locations where the software product may be used, a number of run-time errors, processing resources utilized, memory resources utilized, storage resources utilized, if there are known vulnerabilities, a renewal date, if a contract needs to be reviewed, and so forth.

In some embodiments, vendor management computing platform 110 may detect, via the enterprise network, a new software product hosted by the enterprise computing infrastructure. For example, when a new software product is added to enterprise network management infrastructure 120, vendor management computing platform 110 may detect the new software product and track usage of the new software product. In some embodiments, vendor management computing platform 110 may automatically add a new row to the tabulated list, where the new row comprises network information for the new software product. Although some columns may not have data available for some time, the tabulated list may be updated as network information is analyzed.

In some embodiments, vendor management computing platform 110 may train a machine learning model to, based on an analysis of a utilization of the software product, re-deploy existing licenses of the software product across the enterprise infrastructure. For example, vendor management computing platform 110 may include a machine learning component that is trained to learn from one or more tasks performed by vendor management computing platform 110. For example, one business unit may prioritize renewals based on product usage scores, whereas another business unit may prioritize renewals based on product compliance scores. Accordingly, the machine learning model may be trained to learn preferences of respective business units.

As another example, one business unit may seek to add licenses to a software product whereas another business unit may have a low product usage score. Accordingly, the machine learning model may be trained to review the product usage scores for each business unit and redeploy the licenses to optimize use. Such a redeployment of existing resources may also reduce a cost of licensing and/or purchasing the software product.

Also, for example, the machine learning model may be trained to learn to prepare the model clauses, as described herein. In some embodiments, the machine learning model may be trained to track a change to a model clause during a contract negotiation process and update the model clause based on a determination of a risk profile. For example, one business unit may be more amenable to a decrease in limitation of liability terms, whereas another business unit may be less amenable to a decrease in the limitation of liability terms. Accordingly, the machine learning model may be trained to learn such variance, and recommend different model clauses, corresponding to the limitation of liability terms, to the different business units.

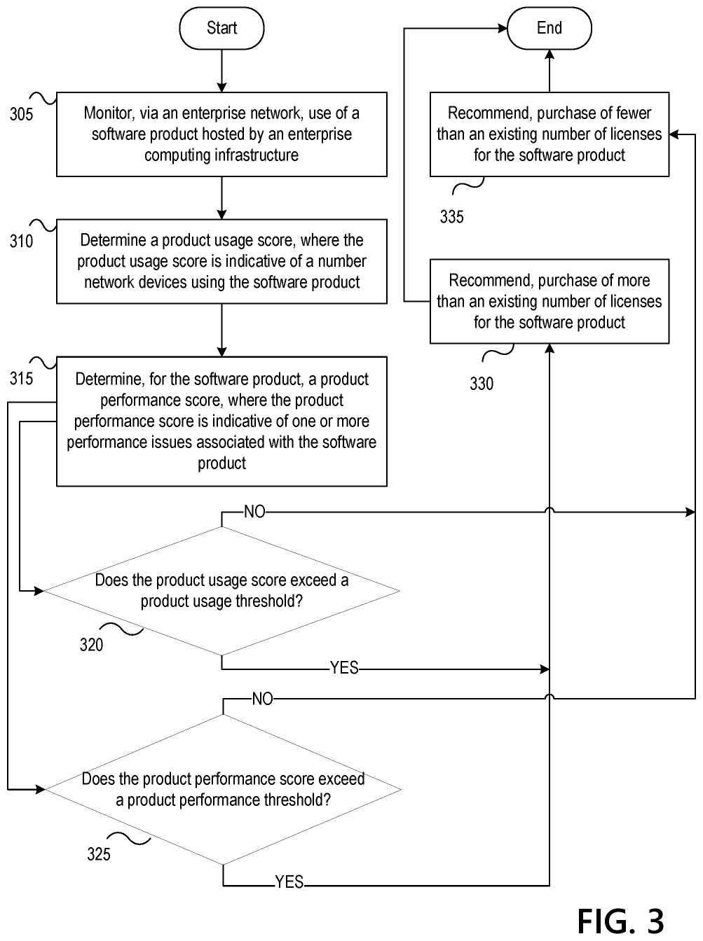

FIG. 3 depicts an illustrative method for a cognitive automation based vendor compliance system in accordance with one or more example embodiments. Referring to FIG. 3, at step 305, a computing platform having at least one processor, and memory may monitor, via an enterprise network, use of a software product hosted by an enterprise computing infrastructure. At step 310, the computing platform may determine a product usage score, where the product usage score is indicative of a number network devices using the software product. At step 315, the computing platform may determine, for the software product, a product performance score, where the product performance score is indicative of one or more performance issues associated with the software product.

At step 320, the computing platform may determine whether the product usage score exceeds a product usage threshold. Upon a determination that the product usage score exceeds the product usage threshold, the process moves to step 330. Upon a determination that the product usage score does not exceed the product usage threshold, the process moves to step 335.

At step 325, the computing platform may determine whether the product performance score exceeds a product performance threshold. Upon a determination that the product performance score exceeds the product performance threshold, the process moves to step 330. Upon a determination that the product performance score does not exceed the product performance threshold, the process moves to step 335.

At step 330, the computing platform may recommend, purchase of more than an existing number of licenses for the software product.

At step 335, the computing platform may recommend, purchase of less than an existing number of licenses for the software product.

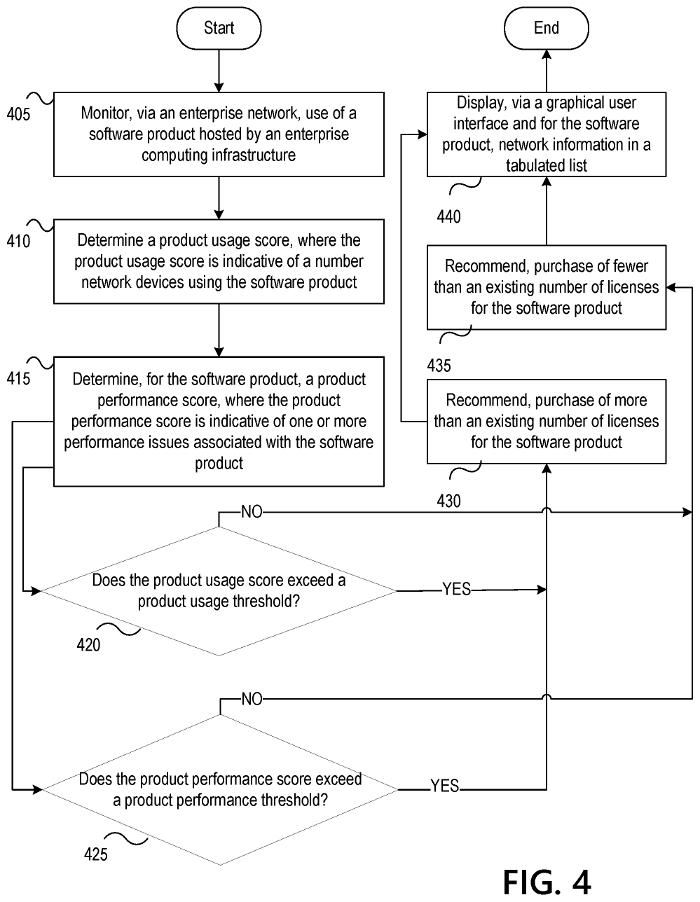

FIG. 4 depicts an illustrative method for a cognitive automation based vendor compliance system in accordance with one or more example embodiments. Referring to FIG. 4, at step 405, a computing platform having at least one processor, and memory may monitor, via an enterprise network, use of a software product hosted by an enterprise computing infrastructure. At step 410, the computing platform may determine a product usage score, where the product usage score is indicative of a number network devices using the software product. At step 415, the computing platform may determine, for the software product, a product performance score, where the product performance score is indicative of one or more performance issues associated with the software product.

At step 420, the computing platform may determine whether the product usage score exceeds a product usage threshold. Upon a determination that the product usage score exceeds the product usage threshold, the process moves to step 430. Upon a determination that the product usage score does not exceed the product usage threshold, the process moves to step 435.

At step 425, the computing platform may determine whether the product performance score exceeds a product performance threshold. Upon a determination that the product performance score exceeds the product performance threshold, the process moves to step 430. Upon a determination that the product performance score does not exceed the product performance threshold, the process moves to step 435.

At step 430, the computing platform may recommend, purchase of more than an existing number of licenses for the software product. The process may proceed to step 440.

At step 435, the computing platform may recommend, purchase of less than an existing number of licenses for the software product. The process may proceed to step 440.

At step 440, the computing platform may display, in near real-time and via a graphical user interface and for the software product, network information in a tabulated list comprising at least one of: the product usage score, the product usage threshold, the product performance score, the product performance threshold, and a cost of the software product.

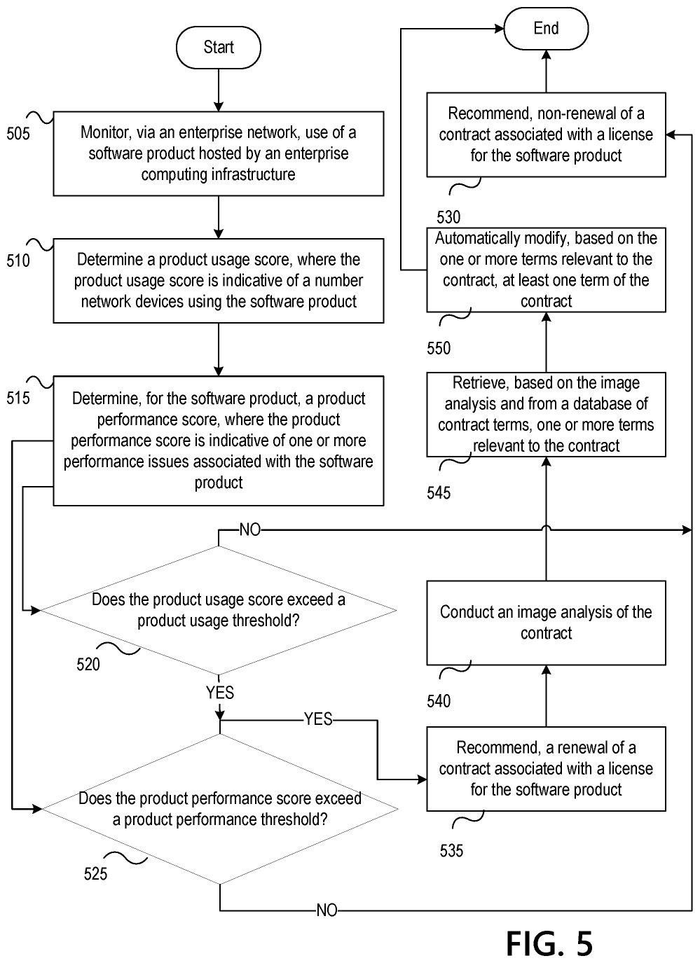

FIG. 5 depicts an illustrative method for a cognitive automation based vendor compliance system in accordance with one or more example embodiments. Referring to FIG. 5, at step 505, a computing platform having at least one processor, and memory may monitor, via an enterprise network, use of a software product hosted by an enterprise computing infrastructure. At step 510, the computing platform may determine a product usage score, where the product usage score is indicative of a number network devices using the software product. At step 515, the computing platform may determine, for the software product, a product performance score, where the product performance score is indicative of one or more performance issues associated with the software product.

At step 520, the computing platform may determine whether the product usage score exceeds a product usage threshold. Upon a determination that the product usage score does not exceed the product usage threshold, the process moves to step 530. Upon a determination that the product usage score exceeds the product usage threshold, the process moves to step 535.

At step 525, the computing platform may determine whether the product performance score exceeds a product performance threshold. Upon a determination that the product performance score does not exceed the product performance threshold, the process moves to step 530. Upon a determination that the product performance score exceeds the product performance threshold, the process moves to step 535.

At step 530, the computing platform may recommend non-renewal of a contract associated with a license for the software product.

At step 535, the computing platform may recommend a renewal of a contract associated with a license for the software product. The process may proceed to step 540.

At step 540, the computing platform may conduct an image analysis of the contract.

At step 545, the computing platform may retrieve, based on the image analysis and from a database of contract terms, one or more terms relevant to the contract.

At step 550, the computing platform may automatically modify, based on the one or more terms relevant to the contract, at least one term of the contract.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular time-sensitive tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor; and
memory storing computer-readable instructions that, when executed by the at least one processor, cause the computing platform to:
monitor, via an enterprise network, use of a software product hosted by an enterprise computing infrastructure;
determine a product usage score, wherein the product usage score is indicative of a number network devices using the software product;
determine, for the software product, a product performance score, wherein the product performance score is indicative of one or more performance issues associated with the software product;
compare, for the software product, at least one of: (1) the product usage score to a product usage threshold, and (2) the product performance score to a product performance threshold; and
recommend, based on the comparing, one or more actions associated with the software product.

2. The computing platform of claim 1, wherein the instructions comprise additional computer-readable instructions that, when executed by the at least one processor, cause the computing platform to:
display, in near real-time and via a graphical user interface and for the software product, network information in a tabulated list comprising at least one of: the product usage score, the product usage threshold, the product performance score, the product performance threshold, and a cost of the software product.

3. The computing platform of claim 2, wherein the instructions comprise additional computer-readable instructions that, when executed by the at least one processor, cause the computing platform to:
detect, via the enterprise network, a new software product hosted by the enterprise computing infrastructure; and
automatically add a new row to the tabulated list, wherein the new row comprises network information for the new software product.

4. The computing platform of claim 1, wherein the instructions comprise additional computer-readable instructions that, when executed by the at least one processor, cause the computing platform to:
train a machine learning model to, based on an analysis of a utilization of the software product, re-deploy existing licenses of the software product across the enterprise infrastructure.

5. The computing platform of claim 1, wherein the instructions comprise additional computer-readable instructions that, when executed by the at least one processor, cause the computing platform to:
determine a product score by aggregating the product usage score and the product performance score;
determine a vendor value for a vendor by aggregating product scores for all software products associated with the vendor;
compare the vendor value to a threshold vendor value; and
upon a determination that the vendor value for the vendor does not exceed the threshold vendor value for a predetermined time threshold, automatically determine not to renew one or more of the software products associated with the vendor.

6. The computing platform of claim 1, wherein the product usage threshold is based on a number of a licenses available for the software product.

7. The computing platform of claim 1, wherein the product usage threshold is based on a cost of the software product.

8. The computing platform of claim 7, wherein the instructions comprise additional computer-readable instructions that, when executed by the at least one processor, cause the computing platform to:
determine the cost of the software product based on a cost of one or more of: an associated operating system, an associated database, and an associated charting library.

9. The computing platform of claim 1, wherein the instructions to compare the product usage score to the product usage threshold comprise additional computer-readable instructions that, when executed by the at least one processor, cause the computing platform to:
determine that the product usage score exceeds the product usage threshold, and
wherein the one or more actions comprise recommending purchase of additional licenses for the software product.

10. The computing platform of claim 1, wherein the instructions to compare the product usage score to the product usage threshold comprise additional computer-readable instructions that, when executed by the at least one processor, cause the computing platform to:
determine that the product usage score does not exceed the product usage threshold for a predetermined time threshold, and
wherein the one or more actions comprise recommending purchase of fewer than an existing number of licenses for the software product.

11. The computing platform of claim 1, comprising additional computer-readable instructions that, when executed by the at least one processor, cause the computing platform to:
determine a minimum product usage threshold, and
wherein the instructions to compare the product usage score to the product usage threshold comprise additional computer-readable instructions that, when executed by the at least one processor, cause the computing platform to:
determine that the product usage score does not exceed the minimum product usage threshold for a predetermined time threshold, and
wherein the one or more actions comprise recommending no further purchase of the software product.

12. The computing platform of claim 1, wherein the product performance threshold is based on one or more of: a number of bugs identified in the software product, a number of breaches associated with the software product, a time spent on resolving performance issues associated with the software product, a length of time the software product is in use, an amount of network resources utilized by the software product, an impact on other network devices, an impact on other software products, and a cost of maintenance associated with the software product.

13. The computing platform of claim 1, wherein the instructions to compare the product performance score to the product performance threshold comprise additional computer-readable instructions that, when executed by the at least one processor, cause the computing platform to:
determine that the product performance score exceeds the product performance threshold, and
wherein the one or more actions comprise recommending purchase of more than an existing number of licenses for the software product.

14. The computing platform of claim 1, wherein the instructions to compare the product performance score to the product performance threshold comprise additional computer-readable instructions that, when executed by the at least one processor, cause the computing platform to:
determine that the product performance score does not exceed the product performance threshold for a predetermined time threshold, and
wherein the one or more actions comprise recommending purchase of less than an existing number of licenses for the software product.

15. The computing platform of claim 1, wherein the instructions to determine the product performance score comprise additional computer-readable instructions that, when executed by the at least one processor, cause the computing platform to:
determine a product compliance score indicative of a level of compliance of the software product with enterprise policies.

16. The computing platform of claim 1, wherein the one or more actions comprise recommending a renewal of a contract associated with a license for the software product, and wherein the instructions comprise additional computer-readable instructions that, when executed by the at least one processor, cause the computing platform to:
conduct an image analysis of the contract;
retrieve, based on the image analysis and from a database of contract terms, one or more terms relevant to the contract;
compare terms of the contract to the one or more terms relevant to the contract; and
identify, based on the comparing of terms, at least one term of the contract for review.

17. The computing platform of claim 16, wherein the instructions comprise additional computer-readable instructions that, when executed by the at least one processor, cause the computing platform to:
automatically modify, based on the comparing of terms, the at least one term.

18. The computing platform of claim 1, wherein the instructions comprise additional computer-readable instructions that, when executed by the at least one processor, cause the computing platform to:
determine that a second software product provides similar functionalities as the software product, and
wherein the instructions to recommend the one or more actions comprise additional computer-readable instructions that, when executed by the at least one processor, cause the computing platform to:
select between the software product and the second software product.

19. A method, comprising:
at a computing platform comprising at least one processor, and memory:
monitoring, via an enterprise network, use of a software product hosted by an enterprise computing infrastructure;
determining a product usage score, wherein the product usage score is indicative of a number network devices using the software product;
determining, for the software product, a product performance score, wherein the product performance score is indicative of one or more performance issues associated with the software product;
comparing, for the software product, at least one of: (1) the product usage score to a product usage threshold, and (2) the product performance score to a product performance threshold;
recommending, based on the comparing, one or more actions associated with the software product; and
displaying, in near real-time and via a graphical user interface and for the software product, network information in a tabulated list comprising at least one of: the one or more actions, the product usage score, the product usage threshold, the product performance score, the product performance threshold, and a cost of the software product.

20. One or more non-transitory computer-readable media storing instructions that, when executed by a computing platform comprising at least one processor, and memory, cause the computing platform to:
monitoring, via an enterprise network, use of a software product hosted by an enterprise computing infrastructure;
determining a product usage score, wherein the product usage score is indicative of a number network devices using the software product;
determining, for the software product, a product performance score, wherein the product performance score is indicative of one or more performance issues associated with the software product;
comparing, for the software product, at least one of: (1) the product usage score to a product usage threshold, and (2) the product performance score to a product performance threshold;
recommending, based on the comparing, a renewal of a contract associated with a license for the software product;
conducting an image analysis of the contract;
retrieving, based on the image analysis and from a database of contract terms, one or more terms relevant to the contract; and
automatically modifying, based on the one or more terms relevant to the contract, at least one term of the contract.
